(19) United States
(12) Patent Application Publication
(10) Pub. No.: US 2026/0348608 A1
(43) Pub. Date: Nov. 5, 2026

(54) METHOD AND A SYSTEM FOR OPTIMIZING A HVAC SYSTEM

(71) Applicant: Honeywell International Inc., Charlotte, NC (US)

(72) Inventors: Deepak Sri Paul, Sivakasi (IN); Deepthi Sethuraman, Bangalore (IN)

(21) Appl. No.: 19/198,159

(22) Filed: May 5, 2025

(51) Int. Cl. F24F 11/46; F24F 11/64; G05B 13/02

(52) U.S. Cl. CPC F24F 11/46; F24F 11/64; G05B 13/0265

(57) ABSTRACT

The present disclosure relates to a method for optimizing a HVAC system. The method comprises receiving, from a remote building management (RBM) platform, a plurality of multivariate data of the HVAC system. The method further includes segmenting the plurality of multivariate data into one or more clusters by at least one clustering technique, wherein each cluster in the one or more clusters represents at least one operational pattern of the HVAC system. The method further includes analyzing and identifying patterns that suggest inefficiencies in the at least one operational pattern or identify deviations in the at least one operational pattern indicating faults. The method automatically recommends one or more remedies for the suggested inefficiencies or the identified deviations using a plurality of predefined criteria. The method further includes training a model to automatically detect inefficiencies or deviations in the operational patterns.

### TECHNICAL FIELD

The present disclosure relates to a method and a system for optimizing a HVAC system of a building.

### BACKGROUND

Traditional HVAC systems in buildings often face significant challenges due to their reliance on static settings and simplistic control strategies. These systems are typically designed to operate based on predetermined schedules or fixed parameters such as temperature set points, which fail to account for the dynamic nature of indoor environments. Factors like temperature fluctuations, varying humidity levels, changes in airflow, and building occupancy can all have a profound impact on the system's efficiency, yet traditional systems do not adjust to these changes in real-time. As a result, HVAC systems frequently operate at less-than-optimal levels, leading to wasted energy, increased utility costs, and unnecessary strain on equipment.

Further, traditional HVAC systems often lack the ability to detect faults and inefficiencies in real-time, allowing minor issues to go unnoticed until they escalate into more significant problems. Components such as compressors, filters, and fans can experience wear and tear or malfunction without immediate indication. These undetected issues may reduce system performance, increase energy consumption, or cause more severe failures that result in costly repairs, extensive downtime, or even damage to the system. In many cases, such faults can persist for extended periods, during which time the building occupants may experience discomfort or environmental conditions that are far from ideal.

Another critical issue with traditional HVAC systems is the difficulty in identifying inefficiencies or system malfunctions that may not be immediately apparent. Energy consumption data often lacks the granularity needed to pinpoint specific areas where energy is being wasted or where the system is operating inefficiently. Without an advanced diagnostic system, facility managers may struggle to accurately assess the performance of HVAC equipment, making it challenging to prioritize maintenance or optimize energy usage. This not only leads to higher operational costs but can also hinder efforts to reduce a building's overall environmental impact.

In addition to these operational and financial challenges, buildings with poorly performing HVAC systems may also face regulatory and compliance issues. Many regions have stringent energy efficiency standards for buildings, and non-compliance due to inefficient HVAC performance can result in penalties or fines. Moreover, the inability to effectively maintain or troubleshoot HVAC systems may delay efforts to meet these evolving standards, ultimately putting building owners and managers at a disadvantage both commercially and environmentally.

In conclusion, the traditional HVAC systems face significant challenges due to their reliance on fixed settings and simplistic controls, which fail to adapt to dynamic changes in indoor environments, leading to inefficiencies, wasted energy, and increased operational costs. These systems also lack real-time fault detection, allowing minor issues to escalate into major problems that can result in costly repairs and system downtime. Additionally, the absence of granular energy consumption data makes it difficult for facility managers to identify inefficiencies and optimize performance. Furthermore, poorly performing HVAC systems can lead to regulatory non-compliance, resulting in penalties and hindering efforts to meet evolving energy efficiency standards.

Therefore, there exists a significant opportunity to improve manual control strategies of the traditional HVAC systems. Developing tools that are simple, proactive, self-learning and automatic.

### SUMMARY

This disclosure provides a method and a system for optimizing a HVAC system. In an embodiment, a method for optimizing a HVAC system is disclosed. The method includes receiving, from a remote building management (RBM) platform, a plurality of multivariate data of the HVAC system. The method further includes segmenting the plurality of multivariate data into one or more clusters by at least one clustering technique, wherein each cluster in the one or more clusters represents at least one operational pattern of the HVAC system. The method further includes analyzing the plurality of multivariate data contained in the one or more clusters to identify patterns to suggest inefficiencies in the at least one operational pattern of the HVAC system or identify deviations in the at least one operational pattern indicating faults within the HVAC system.

The method further includes automatically recommending one or more remedies for the suggested inefficiencies or the identified deviations in the at least one operational pattern to optimize the HVAC system using a plurality of predefined criteria and training a model to automatically detect inefficiencies or deviations in the at least one operational pattern in the HVAC system.

In some embodiments, the at least one operational pattern is selected from a group of time-based patterns, zone-based patterns, temperature patterns, humidity patterns, airflow patterns, or a combination of the above.

In some embodiments, each cluster in the one or more clusters represents at least one energy consumption pattern of the HVAC system, the at least one energy consumption pattern is related to the at least one operational pattern of the HVAC system.

In some embodiments, the step of analyzing includes correlating the at least one operational pattern to the corresponding at least one energy consumption pattern to suggest inefficiencies or identify deviations in the at least one operational pattern of the HVAC system.

In some embodiments, the step of training includes incorporating constant feedback to the model via the step of analyzing and recommending and incorporating feedback from maintenance interventions and past energy performance data of the HVAC system.

In some embodiments, training the model includes providing feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

In some embodiments, the method further comprising alerting a user about the identified inefficiencies or the predicted potential inefficiencies in the at least one operational pattern of the HVAC system.

In some embodiments, the step of alerting comprises triggering a SMS alert to the user on a user device about the identified inefficiencies or the predicted potential inefficiencies in the at least one operational pattern of the HVAC system along with the one or more remedies.

In some embodiments, the method further includes implementing, based on a user's response, at least one or more remedies on the HVAC system.

In some embodiments, the suggested inefficiencies or identified deviations indicates an undue high-temperature zone, an undue low-temperature zone, an undue high airflow zone, an undue low airflow zone, an undue high-humidity zone, an undue low-humidity zone, or a combination of the above.

In some embodiments, the at least one clustering technique is selected from a group of k-means clustering, hierarchical clustering, and Gaussian mixture models (GMM).

In some embodiments, the method further includes cleaning the plurality of multivariate data before segmenting the plurality of multivariate data and performing a data analysis on the cleaned multivariate data.

In yet another embodiment, a system for optimizing a HVAC system is disclosed. The system for optimizing a HVAC system includes a data receiving module configured to receive a plurality of multivariate data of the HVAC system from a Remote Building Management (RBM) platform. The system further includes a data segmenting module that is configured to segment the plurality of multivariate data into one or more clusters by at least one clustering technique, wherein each cluster in the one or more clusters represents at least one operational pattern of the HVAC system. The system further includes a data analyzing module that is configured to analyze the plurality of multivariate data contained in the one or more clusters to identify patterns to suggest inefficiencies in the at least one operational pattern of the HVAC system or identify deviations in the at least one operational pattern indicating faults within the HVAC system. The system further includes a recommendation module that is configured to automatically recommend one or more remedies for the suggested inefficiencies or the identified deviations in the at least one operational pattern to optimize the HVAC system using a plurality of predefined criteria. The system further includes a training module that is configured to train a model to automatically detect inefficiencies or deviations in the at least one operational pattern in the HVAC system.

In some embodiments, the at least one operational pattern is selected from a group of time-based patterns, zone-based patterns, temperature patterns, humidity patterns, airflow patterns, or a combination of the above.

In some embodiments, each cluster in the one or more clusters represents at least one energy consumption pattern of the HVAC system, the at least one energy consumption pattern is related to the at least one operational pattern of the HVAC system.

In some embodiments, the data analyzing module further configured to correlate the at least one operational pattern to the corresponding at least one energy consumption pattern to suggest inefficiencies or identify deviations in the at least one operational pattern of the HVAC system.

In some embodiments, the training module further includes a feedback module configured to provide constant feedback to the model via the data analyzing module and the recommendation module, and is further configured to incorporate feedback from maintenance interventions and past energy performance data of the HVAC system.

In some embodiments, the training module that is further configured to provide feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

In some embodiments, the system further comprises an alert module that is configured to alert a user of the identified inefficiencies or the predicted potential inefficiencies in the at least one operational pattern of the HVAC system by triggering a SMS alert to the user on a user device about the identified inefficiencies or the predicted potential inefficiencies in the at least one operational pattern of the HVAC system along with the one or more remedies.

In yet another embodiment, a non-transitory computer-readable medium is disclosed, having stored thereon computer-readable instructions that, when executed by a processor, cause the processor to execute a method for optimizing a HVAC system. The method comprises receiving a certificate of a building management system. The method includes receiving, from a remote building management (RBM) platform, a plurality of multivariate data of the HVAC system. The method includes receiving, from a remote building management (RBM) platform, a plurality of multivariate data of the HVAC system. The method further includes analyzing the plurality of multivariate data contained in the one or more clusters to identify patterns to suggest inefficiencies in the at least one operational pattern of the HVAC system or identify deviations in the at least one operational pattern indicating faults within the HVAC system. The method further includes automatically recommending one or more remedies for the suggested inefficiencies or the identified deviations in the at least one operational pattern to optimize the HVAC system using a plurality of predefined criteria and training a model to automatically detect inefficiencies or deviations in the at least one operational pattern in the HVAC system.

To overcome the challenges mentioned in the background section, a system and a method for optimizing a HVAC system is disclosed. Integrating the solution that optimizes HVAC systems in buildings for improving energy efficiency, especially with the growing focus on sustainability and reducing operational costs. The disclosed system automatically adjusts HVAC settings based on real-time data collected from various sensors and monitoring systems within the building. The system collects data on factors like temperature, humidity, occupancy, and external weather conditions. With this information, the system can make dynamic adjustments to HVAC settings such as airflow rates, cooling/heating set points, and air distribution patterns, ensuring that each zone in the building receives just the right amount of conditioning based on current needs. For example, areas that are unoccupied or have low traffic may be set to a more energy-efficient temperature, while zones with higher occupancy levels could be conditioned more precisely to maintain comfort and save energy.

The system for optimizing a HVAC system significantly prevents over-conditioning or under-conditioning, which is a common issue in traditional HVAC systems. Over-conditioning leads to wasted energy and higher utility bills, while under-conditioning can compromise comfort levels for building occupants. By optimizing airflow and temperature across different zones, the system minimizes unnecessary energy consumption, ensuring that energy is only used when and where it is needed. Furthermore, the ability of the system to track and analyze energy use patterns over time allows the system to identify inefficiencies or anomalies in the HVAC performance, providing opportunities for further optimization and preventive maintenance. The proactive approach here, not only reduces the carbon footprint of the building but also prolongs the lifespan of HVAC equipment, leading to lower maintenance and replacement costs eventually. Overall, such a system offers a significant reduction in operational costs while supporting the building's environmental goals.

One of the most compelling advantages of the disclosed system is proactive maintenance scheduling. By implementing the system for optimizing the HVAC system in buildings, it ensures the system operates at peak performance and minimizes the risk of system failures. The system utilizes real-time data collected from sensors embedded within the HVAC units to monitor various performance parameters, such as airflow, temperature, pressure, and energy consumption. By continuously analyzing these parameters, the system can detect abnormal patterns that could indicate potential issues, such as low airflow or irregular energy spikes.

For instance, if the airflow within a particular zone decreases while energy consumption remains high, this could be a sign of a clogged filter, a malfunctioning fan, or duct leakage. In traditional systems, these issues might go unnoticed until they cause significant disruptions or complete breakdowns. However, the disclosed system continuously monitors the HVAC's performance and identifies these anomalies early on, allowing for timely intervention before the situation worsens.

Once a potential issue is detected, the system can generate automatic alerts that notify building managers or maintenance teams. These alerts provide details on the nature of the anomaly, its location, and its potential impact on system performance. This early warning allows maintenance personnel to prioritize tasks based on the severity of the problem, preventing unnecessary downtime and costly emergency repairs. For example, a simple filter replacement can be scheduled before it escalates into a more expensive repair, such as a malfunctioning compressor due to poor airflow.

By scheduling such maintenance activities proactively, the HVAC system's overall reliability is greatly improved. Regular and timely interventions prevent small issues from turning into bigger issues, more expensive problems. Additionally, this approach helps in reducing the likelihood of unexpected breakdowns, which can disrupt building operations and comfort.

The system can further help with the optimization of spare parts inventory by tracking parts that are likely to need replacement or servicing soon. By predicting the maintenance needs in advance, the system ensures that necessary parts are available when required, reducing lead time and avoiding delays in repairs. Proactive maintenance scheduling also contributes to longer equipment lifespans, as HVAC units are kept in good working order, reducing the stress placed on components. This ultimately lowers long-term maintenance and replacement costs, resulting in better cost control and improved return on investment for building owners.

The system's proactive maintenance scheduling optimizes the HVAC system by ensuring timely identification and resolution of issues, reducing downtime, extending equipment life, and improving overall system performance. This contributes significantly to lowering operational costs and enhancing the building's overall energy efficiency and comfort levels.

Another advantage of the system is data-driven decision making for optimizing HVAC systems in buildings. This further ensures that operational adjustments and maintenance tasks are based on real-time, accurate data rather than assumptions or outdated information. With an optimized HVAC system, the continuous flow of data from sensors embedded throughout the building allows for precise monitoring of various variables, including temperature, humidity, air quality, airflow, energy consumption, and occupancy patterns. This real-time data provides a comprehensive and up-to-date picture of the building's operational environment, enabling smarter decision making.

For example, based on real-time temperature readings and occupancy data, the system can dynamically adjust HVAC settings to ensure that rooms or areas with higher foot traffic are adequately conditioned, while unused areas can be set to more energy-efficient temperatures. The system also takes into account factors such as outside weather conditions, time of day, and building usage patterns. By relying on this accurate data, the HVAC system can make adjustments that ensure comfort without unnecessary energy consumption, optimizing both operational efficiency and cost-effectiveness.

Additionally, data-driven decision making allows building managers to make more informed choices regarding maintenance and upgrades. When the system collects data on the performance of HVAC components over time, it can highlight trends that signal wear and tear or inefficiencies. For instance, if energy consumption is increasing despite normal operating conditions, it could point to an issue with a particular HVAC unit, such as a malfunctioning compressor or air filter. In this case, the system can generate actionable insights and notify maintenance personnel about potential issues, ensuring timely and targeted repairs. This data allows decisions on when and where to conduct maintenance to be more precise, avoiding unnecessary inspections or replacements.

The use of real-time data also enhances long-term decision making, such as when planning for system upgrades or replacements. By analyzing historical performance data, building managers can determine whether existing equipment is operating optimally or if it would be more cost-effective to replace certain components with newer, more efficient technologies. This helps ensure that investments in building systems are based on concrete data rather than guesswork or rough estimations. Moreover, the ability to track and evaluate data continuously creates a feedback loop that enables ongoing improvement. The system can be calibrated over time based on the data collected, allowing for finer adjustments that further enhance energy savings, comfort, and system efficiency. This leads to more effective resource allocation and the ability to continually optimize operations in line with changing conditions, whether due to seasonal shifts, occupancy changes, or updates in building infrastructure.

The data-driven decision making of the system ensures that HVAC systems are optimized in a precise and timely manner. By relying on accurate, real-time data, building managers and systems can make smarter adjustments, prioritize maintenance based on real issues, and improve long-term operational strategies. This approach not only enhances energy efficiency and comfort but also enables buildings to operate more sustainably and cost-effectively.

Other technical features may be readily apparent to one skilled in the art from the following figures, descriptions, and claims. This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF THE DRAWINGS

For a more complete understanding of this disclosure and its features, reference is now made to the following description, taken in conjunction with the accompanying drawings, in which:

FIG. 1 illustrates a flowchart of a method for optimizing a HVAC system according to an embodiment of the disclosure;

FIG. 2 illustrates a system optimizing a HVAC system in a building according to an embodiment of the disclosure;

FIG. 3 illustrates a schematic system for optimizing a HVAC system, according to an embodiment of the disclosure; and

FIG. 4 illustrates a diagram of a communication apparatus according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

In a building management system (BMS), the HVAC (heating, ventilation, and air conditioning) system is designed to ensure efficient temperature control, air quality, and energy management of the building. The HVAC system relies on various sensors, controllers, actuators, and equipment, all working in coordination to maintain the optimal environment.

Any HVAC system in a Building Management System works by continuously gathering data from sensors, processing that data through controllers, and then adjusting HVAC components such as actuators and equipment to maintain the desired environment, manually. The supervisor overseeing the HVAC system ensures its optimal operation, and intervening when necessary to optimize performance, address issues, and manage energy efficiency. The HVAC system relies on a combination of sensors, controllers, actuators, and equipment to create a comfortable, efficient indoor environment. Sensors gather real-time data, controllers process it and make decisions, actuators adjust the system's operation, and HVAC equipment delivers the necessary heating, cooling, and ventilation to maintain ideal conditions throughout the building.

The sensors in the HVAC system are strategically placed throughout the building to monitor environmental conditions. These sensors continuously collect data, which is then transmitted to the central controller within the BMS. The central controller (often a PLC or dedicated server) processes this data to determine the threshold. For example, if the temperature in a room exceeds a set threshold, the controller will trigger the HVAC system to take action. The sensors are vital for continuously monitoring environmental conditions within the building. Temperature sensors detect the air temperature in various zones, allowing the system to regulate heating or cooling as needed. Humidity sensors monitor the moisture level in the air, helping to prevent issues like excess moisture or dry air, which could affect both comfort and building materials. Air quality sensors measure factors like CO2 levels, particulate matter, and other pollutants, ensuring that the air remains fresh and safe. These sensors send real-time data to the building management system (BMS).

In the HVAC system, the controllers are one of the key components in the system. Thermostats are typically located in various zones of the building, allowing occupants or facility managers to set desired temperatures. The BMS uses this input, along with sensor data, to manage the operation of HVAC equipment. The supervisor oversees the overall functioning of the HVAC system, reviewing real-time data, setting operational parameters, and intervening when necessary to optimize performance, energy consumption, or respond to any system malfunctions.

Further, the controllers, including the central controller and local thermostats, are the brains of the HVAC system. The central controller, typically a programmable logic controller (PLC) or a BMS server, processes data from the sensors and compares it to predefined set-points (such as target temperature or humidity levels). Based on this analysis, the controller makes basic decisions about how to adjust the HVAC system's operation. Local thermostats allow occupants or facility managers to set specific temperature preferences for individual rooms or zones. These devices communicate with the central controller, ensuring that the building's climate matches the desired conditions.

The actuators in the HVAC system are responsible for physically adjusting the HVAC system. These components receive signals from the controller to regulate the flow of air, water, or refrigerant, ensuring proper temperature and ventilation in the building. For instance, dampers control the airflow through the ducts, while fans ensure air circulation. These actuators are the components that physically adjust the HVAC system's operation in response to commands from the controllers. Valves control the flow of heating or cooling fluids (like water or refrigerants) through the system, ensuring that the right amount of heat or coolness is delivered to each part of the building. Dampers regulate the flow of air in the ducts, directing airflow to different zones as needed. Fans help circulate air throughout the building, ensuring that conditioned air reaches all areas. The actuators work together to control temperature, humidity, and air quality by adjusting the system's physical components based on real-time data and pre-set conditions.

Finally, the core HVAC equipment is responsible for generating and distributing heating or cooling to the building. AHUs manage the flow of air, while chillers provide cooling through refrigeration, and boilers supply heating. Additionally, Variable Air Volume (VAV) boxes may be used to control airflow in specific building zones based on demand, further optimizing comfort and energy usage.

The HVAC equipment includes the large machines that provide heating, cooling, and ventilation. Air Handling Units (AHUs) condition the air by filtering it, adjusting its temperature, and adding or removing moisture, as necessary. These units circulate the conditioned air through the building via ducts. Chillers provide cooling by removing heat from the air using a refrigeration cycle and circulating chilled water or refrigerant throughout the building. Boilers generate heat by burning fuel or using electricity to warm water, which is then distributed for space heating. These pieces of equipment are managed by the BMS to ensure that heating and cooling needs are met efficiently, adjusting their operation based on the data received from sensors and controllers.

Further, there is a user interface in all HVAC systems, typically a BMS dashboard. This allows the supervisor and facility managers to monitor the real-time performance of the HVAC system, view reports, and make manual adjustments. The supervisor or facility managers usually set critical parameters, such as temperature set points, humidity levels, and air quality targets for its proper functioning. The supervisor may also troubleshoot any issues as and when they arise.

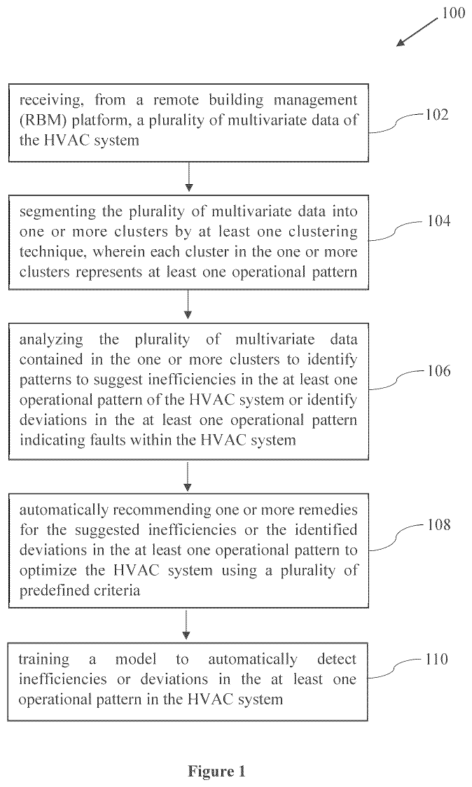

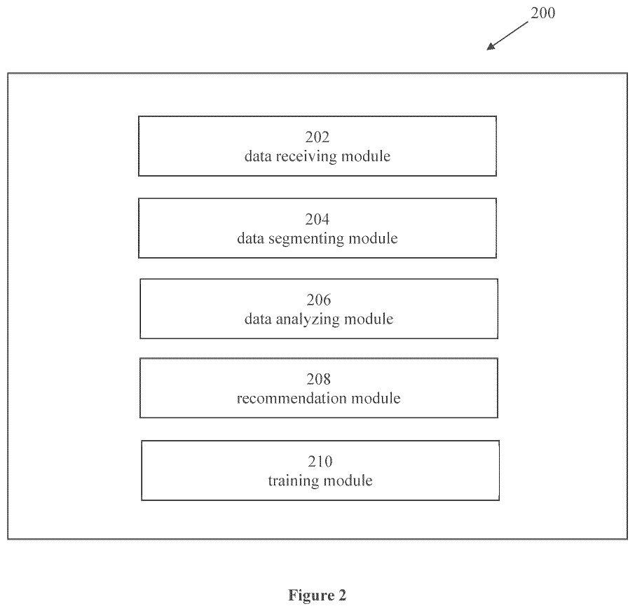

FIG. 1 illustrates a flowchart of a method for optimizing a HVAC system in a building management system hereinafter interchangeably referred to as “method 100”. The method 100 could be used with any suitable device and in conjunction with any suitable system. For example, the method 100 is performed by a system 200 (explained in detail in FIG. 2).

The method 100 comprises receiving, from a remote building management (RBM) platform, a plurality of multivariate data of the HVAC (Heating, Ventilation, and Air Conditioning) system, as shown in step 102. This step could include, for example, receiving data from a wide variety of sources, including environmental sensors (temperature, humidity, air quality), mechanical sensors (pressure, flow), energy consumption and user inputs (set-points, control devices). The building management system (BMS) and/or the remote building management (RBM) store all the collected data on the cloud.

The HVAC system gathers data from a wide array of sensors and devices located throughout the building. This data collection is essential for maintaining optimal comfort, air quality, and energy efficiency. Each sensor plays a vital role in monitoring different aspects of the building's environment and HVAC performance.

According to an embodiment, temperature sensors are one of the primary data sources in the BMS, located in various zones or rooms within the building. These sensors continuously monitor the indoor temperature and feed this information back to the system 200, which uses this data to adjust heating or cooling to ensure the building maintains the desired temperature set-points. For example, if the temperature in a room rises above the set-point, the system 200 will trigger the air conditioning to bring it back down. Similarly, when the temperature drops too low, the heating system is activated. Temperature sensors are crucial for ensuring the comfort of building occupants.

According to another embodiment, humidity sensors are another critical component of the HVAC data-gathering process. These sensors measure the relative humidity levels in the air. Maintaining an optimal humidity level is vital for comfort and air quality. The BMS collects humidity data for the system 200 to regulate humidifiers or dehumidifiers. For instance, if the humidity level exceeds the desired range, the system 200 may activate a dehumidifier to reduce moisture in the air, or if the air is too dry, a humidifier may be engaged to add moisture. This helps prevent issues like dry skin, etc.

According to another embodiment, air quality sensors are increasingly becoming a standard in modern HVAC systems. These sensors track pollutants such as carbon dioxide (CO2), volatile organic compounds (VOCs), and particulate matter in the air. The BMS collects the air quality data to inform the system 200 which shall adjust the ventilation rates in different areas of the building. For example, if the CO2 levels rise in an occupied room, the system 200 may increase the amount of outdoor air being circulated to improve ventilation. This not only helps in ensuring occupant comfort but also contributes to overall indoor air quality, which is important for health and productivity.

According to another embodiment, pressure sensors installed within the HVAC system's ducts measure the air pressure, ensuring that airflow is maintained at the correct levels. These sensors provide crucial feedback on whether the ducts are functioning efficiently or if there are issues such as clogged filters or blocked ducts that could reduce airflow. The system 200 ensures that heating and cooling are distributed effectively throughout the building.

According to another embodiment, flow sensors are used to monitor the flow of air or water through the HVAC system, depending on whether the HVAC system is air-based or uses hydronic (water) components. These sensors ensure that the flow rate remains consistent and optimal, as improper flow can lead to inefficiencies and poor temperature control. For example, in a hydronic system, flow sensors monitor the movement of hot or chilled water through the pipes, while in an air-based system, they track the volume of air being distributed through ducts.

According to another embodiment, occupancy sensors are often integrated into the HVAC system to help optimize energy usage. These sensors detect whether a room or area is occupied or unoccupied. Based on occupancy data, the system 200 can adjust heating, cooling, and ventilation to reflect real-time needs. For instance, if a conference room is empty, the system 200 might reduce heating or cooling to save energy. Conversely, when the room becomes occupied, the system 200 adjusts to maintain comfort levels.

According to another embodiment, set-points and control devices are key sources of data that allow users to interact with the HVAC system and adjust the desired conditions in different areas of the building. These include thermostats, control panels, and other user input devices that set parameters like temperature, humidity, and airflow. The BMS constantly monitors these settings and collects the data for system 200 accordingly. If the set-point changes, such as when a user increases the thermostat temperature, the system 200 will respond by adjusting the heating or cooling output to meet the new requirement.

According to another embodiment, building automation data, including external data from weather stations or forecasts, plays a significant role in the HVAC data-gathering process. The BMS collects data from external sources, such as outdoor temperature, humidity, and air pressure, to anticipate the building's heating or cooling needs. For example, if the outside temperature rises significantly, the system 200 may adjust the internal temperature or ventilation levels to compensate. Additionally, data from other building systems, such as lighting and shading, can influence HVAC operation. For example, if a room's lights are on or if blinds are open, this can affect the internal temperature and the system 200 may adjust HVAC settings accordingly to maintain comfort.

According to another embodiment, equipment data from the HVAC system's internal components, such as chillers, boilers, air handling units (AHUs), fans, and pumps, also feed into the BMS. These components have built-in sensors that track performance metrics like motor speed, energy consumption, and operational status.

According to another embodiment, collecting energy consumption data in a Building Management System (BMS) for HVAC systems is crucial for monitoring and optimizing energy efficiency. The BMS acts as a central control system that integrates various building systems, including HVAC, lighting, and security. By using sensors, sub-meters, and data loggers, the BMS collects real-time data on energy use from different components of the HVAC system, such as compressors, fans, pumps, and chillers etc.

The method 100 further comprises segmenting the plurality of multivariate data into one or more clusters by at least one clustering technique, wherein each cluster in the one or more clusters represents at least one operational pattern of the HVAC system, as shown in step 104.

According to an embodiment, clustering techniques comprises of grouping data points based on their similarity with each other. This technique is defined under the branch of unsupervised learning, which aims at gaining insights from unlabelled data points. For example, think of a dataset of customers shopping habits. Clustering can help you group customers with similar purchasing behaviours, which can then be used for targeted marketing, product recommendations, or customer segmentation.

Another example, in buildings, there can be temperature and humidity clustering that may include grouping rooms or zones with similar temperature and humidity profiles to optimize HVAC control using clustering algorithms, like K-means or DBSCAN, which group areas in the building that exhibit similar temperature and humidity behaviour over time. For instance, different floors or rooms might have different heating or cooling needs based on their exposure to sunlight, occupancy, or usage patterns.

Another clustering technique may be applied on air quality and CO2 level in buildings to identify areas with similar air quality levels for efficient ventilation management. Multiple clustering techniques like K-means or Hierarchical clustering, may be used to group areas based on air quality metrics like CO2 levels, particulate matter, and volatile organic compounds (VOCs). By clustering rooms with similar air quality, the system can better manage ventilation needs and ensure healthier environments in high-occupancy areas like meeting rooms or cafeterias.

Further, there can be occupancy pattern clustering that recognizes occupancy patterns. By using time-series clustering techniques or DBSCAN, occupancy sensors can be analyzed to identify periods of high and low occupancy in different rooms or zones. Rooms with similar occupancy patterns e.g., high occupancy during business hours, low occupancy at night can be grouped together.

Another clustering technique may be applied on seasonal or time-based patterns. Sensor data, particularly temperature and humidity, often exhibit seasonal patterns. Time-series clustering using clustering algorithms, like K-means, can group different time periods e.g., seasons, months, or even hours of the day, based on recurring trends in temperature, humidity, and energy usage.

According to an embodiment, the pressure and flow sensor data can be clustered and be used to group zones with similar flow and pressure characteristics. By analyzing pressure and flow data can help detect issues such as blockages, leaks, or improperly adjusted air handling units (AHUs) or pumps.

Further, there can also be a combination of multiple sensor data streams like temperature, humidity, occupancy, energy consumption for holistic optimization. By using a combination of multi-dimensional clustering e.g., K-means with several features cluster multiple types of sensor data to create composite profiles for different areas or times of day. By grouping similar data points together, clustering can further help identify patterns, detect anomalies, and optimize performance.

The method 100 further comprises analyzing the plurality of multivariate data contained in the one or more clusters to identify patterns to suggest inefficiencies in the at least one operational pattern of the HVAC system or identify deviations in the at least one operational pattern indicating faults within the HVAC system, as shown in step 106. This step involves analysis of complex multivariate data from the HVAC system stored in the distinct groups or “clusters,” which represent similar operational behaviour. These clusters are created based on a variety of system parameters such as temperature, humidity, pressure, energy consumption, airflow rates, and system component performance (e.g., compressor or fan speeds).

During analysis, the faulty cluster patterns are identified within each cluster. For instance, if a specific cluster consistently exhibits higher energy consumption without corresponding temperature control efficiency, it could indicate inefficiency in the HVAC system. This inefficiency could arise due to several factors such as faulty components (e.g., a malfunctioning compressor), poor calibration, or improper settings. By identifying such patterns, the system 200 can perform proactive measures to optimize energy use, reduce operational costs, and extend the system's lifespan.

Another critical application of clustering analysis is detecting deviations within operational patterns that may suggest faults in the HVAC system. These deviations can appear as anomalies in the data, such as sudden spikes in power usage, irregular pressure levels, or abnormal temperature fluctuations. A cluster analysis can reveal these discrepancies by comparing current operational data against historical patterns. For example, if the temperature regulation is inconsistent in a particular zone, it could signal that a thermostat or sensor is malfunctioning or that there is a blockage in the airflow. Early detection of these anomalies allows for timely maintenance and repairs, preventing more serious and costly breakdowns.

To get a more granular view of the HVAC system's performance by grouping data into meaningful patterns, thereby allowing for both the identification of inefficiencies (which can be addressed to improve system performance) and the early detection of faults (which can help prevent equipment failure and costly repairs).

The method 100 further comprises automatically recommending one or more remedies for the suggested inefficiencies or the identified deviations in the at least one operational pattern to optimize the HVAC system using a plurality of predefined criteria, as shown in step 108. Automatically recommending remedies for inefficiencies or identified deviations in HVAC system operations involves integrating advanced algorithms and predefined criteria to optimize system performance. After detecting inefficiencies or faults through clustering and pattern recognition, the system 200 can use predefined criteria to assess potential remedies. These criteria could be based on various factors such as energy consumption thresholds, maintenance schedules, environmental conditions, or component-specific performance data. The goal is to create a dynamic, automated decision-making process that suggests corrective actions to address operational issues, ensuring both immediate and long-term improvements.

For inefficiencies such as high energy consumption or suboptimal temperature regulation, the system 200 can analyze historical data and current system performance against a set of benchmarks or best practices. If a deviation from the desired performance is detected, the system 200 might automatically recommend actions like suggesting new set-points, recalibrating thermostats, adjusting airflow rates, or replacing outdated components. These actions can be recommended based on rules that take into account energy usage, cost-effectiveness, and environmental conditions. For instance, if a compressor is found to be operating inefficiently, the system 200 might suggest increasing its maintenance intervals or even replacing it to avoid further energy wastage and potential breakdowns.

When deviations indicative of faults are identified—such as sudden spikes in pressure or unusual system behaviour—the automated system can recommend immediate corrective actions to prevent system failure. For example, if a fault in a valve or sensor is detected, the system 200 might automatically flag the issue, suggest replacing the faulty part, and provide guidelines for technicians to follow. Furthermore, based on the severity and type of deviation, the system 200 could prioritize remedies, directing maintenance teams to address the most critical issues first to avoid operational disruptions.

The method 100 further includes training a model to automatically detect inefficiencies or deviations in the at least one operational pattern in the HVAC system, as shown in step 110. This step involves training a model to automatically detect inefficiencies or deviations in operational patterns in an HVAC (Heating, Ventilation, and Air Conditioning) system. This model is capable of identifying abnormal activity that may indicate a malfunction, energy waste, or suboptimal performance. These inefficiencies can range from improper temperature regulation to faulty equipment or even substandard maintenance practices that affect the system's overall effectiveness and energy consumption.

To train such a model, multivariate data from the HVAC system along with incorporating constant feedback to the model, incorporating feedback from maintenance interventions and past energy performance data of the HVAC system, is collected. This data typically includes temperature readings, humidity levels, airflow rates, energy usage, pressure levels, and sensor data from different components like compressors, fans, or motors, feedback during maintenance, past energy performance etc. This data serves as the foundation for understanding normal operational patterns, which are then used to establish a baseline for comparison. Machine learning algorithms, such as supervised learning, unsupervised learning, or anomaly detection techniques, can then be applied to learn the patterns and behaviours that signify optimal operation.

Once the model is trained, it can continuously monitor the HVAC system's real-time performance, comparing current data with the established baseline. If the system starts to deviate from normal operational patterns—whether in terms of efficiency, energy consumption, or the functioning of key components—the model can flag these anomalies. For instance, if the system is consuming more energy than usual without a corresponding increase in demand, it may suggest that a component is malfunctioning or needs maintenance. Similarly, if temperature regulation is erratic or airflow is insufficient, the model can alert operators to potential issues, helping to prevent system failures and reduce costly repairs.

By automatically detecting inefficiencies or deviations, this type of model not only improves the overall performance of HVAC systems but also contributes to sustainability efforts by minimizing energy waste. Additionally, early detection of system issues allows for proactive maintenance, reducing downtime and extending the lifespan of equipment. This proactive approach ensures that the HVAC system operates at its highest efficiency, saving both energy and operational costs eventually.

Moreover, the model can also adapt its recommendations over time, learning from past interventions and continuously improving its decision-making process. As the HVAC system operates, new data is collected and analyzed, and the system adjusts its suggestions, accordingly, ensuring the remedies remain relevant and effective. By leveraging a combination of real-time data, historical performance insights, and predefined criteria, this automated recommendation process ensures that the HVAC system operates efficiently, minimizing downtime, energy waste, and unnecessary repairs. This proactive approach helps optimize both system performance and overall operational costs.

In an embodiment, the at least one operational pattern is selected from a group of time-based patterns, zone-based patterns, temperature patterns, humidity patterns, airflow patterns, or a combination of the above.

In another embodiment, each cluster in the one or more clusters represents at least one energy consumption pattern of the HVAC system, the at least one energy consumption pattern is related to the at least one operational pattern of the HVAC system.

In another embodiment, the step of analyzing includes correlating the at least one operational pattern to the corresponding at least one energy consumption pattern to suggest inefficiencies or identify deviations in the at least one operational pattern of the HVAC system.

In another embodiment, the the step of training further includes incorporating constant feedback to the model via the step of analyzing and recommending and incorporating feedback from maintenance interventions and past energy performance data of the HVAC system.

In another embodiment, training the model includes providing feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

In another embodiment, the method further comprising alerting a user about the identified inefficiencies or the predicted potential inefficiencies in the at least one operational pattern of the HVAC system. The step of alerting further comprises triggering a SMS alert to the user on a user device about the identified inefficiencies or the predicted potential inefficiencies in the at least one operational pattern of the HVAC system along with the one or more remedies.

In another embodiment, the method further comprising implementing, based on a user's response, at least one or more remedies on the HVAC system.

In another embodiment, the suggested inefficiencies or identified deviations indicates an undue high-temperature zone, an undue low-temperature zone, an undue high airflow zone, an undue low airflow zone, an undue high-humidity zone, an undue low-humidity zone, or a combination of the above.

In another embodiment, the at least one clustering technique is selected from a group of k-means clustering, hierarchical clustering, and Gaussian Mixture Models (GMM).

In another embodiment, the method further comprising cleaning the plurality of multivariate data before segmenting the plurality of multivariate data and performing a data analysis on the cleaned multivariate data.

FIG. 2 illustrates a system 200 optimizing a HVAC system according to an embodiment of the disclosure. The system 200 comprises a data receiving module 202, a data segmenting module 204, a data analyzing module 206, a recommendation module 208 and a training module 210.

The data receiving module 202 is configured to receive a plurality of multivariate data of the HVAC system from a remote building management (RBM) platform.

The data segmenting module 204 is configured to segment the plurality of multivariate data into one or more clusters by at least one clustering technique, wherein each cluster in the one or more clusters represents at least one operational pattern of the HVAC system.

The data analyzing module 206 is configured to analyze the plurality of multivariate data contained in the one or more clusters to identify patterns to suggest inefficiencies in the at least one operational pattern of the HVAC system or identify deviations in the at least one operational pattern indicating faults within the HVAC system.

The recommendation module 208 is configured to automatically recommend one or more remedies for the suggested inefficiencies or the identified deviations in the at least one operational pattern to optimize the HVAC system using a plurality of predefined criteria.

The training module 210 is configured to train a model to automatically detect inefficiencies or deviations in the at least one operational pattern in the HVAC system.

In an embodiment, the at least one operational pattern is selected from a group of time-based patterns, zone-based patterns, temperature patterns, humidity patterns, airflow patterns, or a combination of the above.

In an embodiment, each cluster in the one or more clusters represents at least one energy consumption pattern of the HVAC system, the at least one energy consumption pattern is related to the at least one operational pattern of the HVAC system.

In another embodiment, the data analyzing module 206 is further configured to correlate the at least one operational pattern to the corresponding at least one energy consumption pattern to suggest inefficiencies or identify deviations in the at least one operational pattern of the HVAC system.

In another embodiment, the training module 210 is further comprising a feedback module configured to provide constant feedback to the model via the data analyzing module and the recommendation module 208, and further configured to incorporate feedback from maintenance interventions and past energy performance data of the HVAC system.

In another embodiment, the training module 210 is configured to provide feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

In another embodiment, the system 200 is further comprising an alert module (not shown) configured to alert a user of the identified inefficiencies or the predicted potential inefficiencies in the at least one operational pattern of the HVAC system by triggering a SMS alert to the user on a user device about the identified inefficiencies or the predicted potential inefficiencies in the at least one operational pattern of the HVAC system along with the one or more remedies.

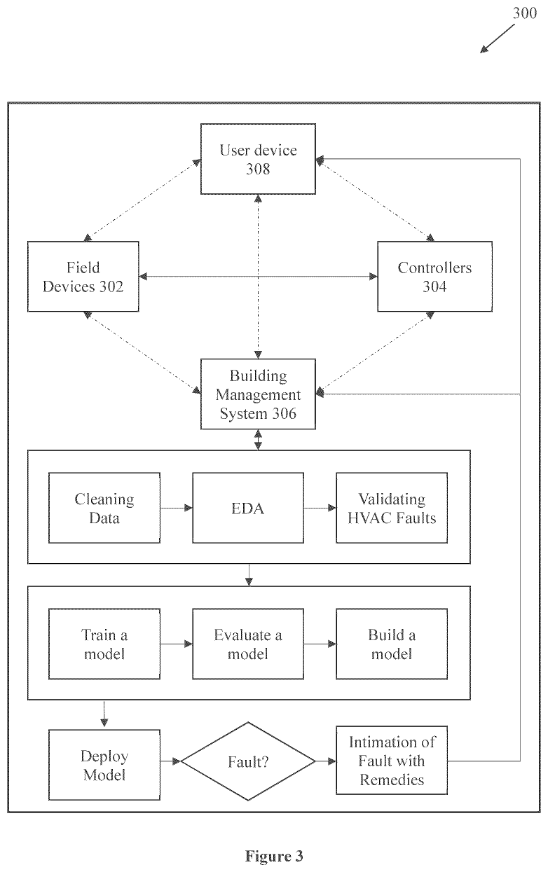

FIG. 3 illustrates a schematic system 300 for optimizing a HVAC system, according to an embodiment of the disclosure. The system comprises of various components which shall be explained below:

Field devices 302 and controllers 304: The field devices 302 like sensors, and actuators, along with controllers 304 (of a HVAC system), work together to ensure the environment is maintained at optimal conditions. These devices are responsible for collecting real-time data, such as temperature, humidity, and air quality. For example, a temperature sensor might detect a rise in temperature beyond the set point and send a signal to the controller 304, which then adjusts the thermostat or HVAC units to cool the area down. The controllers 304 often work autonomously but are linked to a central system like a building management system (BMS) for higher-level coordination and monitoring.

Building Management System (BMS) 306: The BMS 306 acts as a centralized hub that integrates all the field devices in the HVAC system, allowing for seamless management and optimization of energy usage. The BMS aggregates data from various devices and can analyze and adjust the system's performance based on pre-set conditions, scheduling, and real-time factors. The BMS 306 can also offer insights into system efficiency, alerts for maintenance, and notifications of malfunctions. By providing a visual interface, the BMS 306 allows operators to monitor and control various devices within the HVAC system remotely.

User device 308: A user device 308 (associated with a supervisor) such as a tablet, PC, or smartphone—often interfaces directly with the BMS 306 to make adjustments or respond to alerts. These devices 308 allow the supervisor to remotely change settings (such as temperature set points or ventilation levels) and receive immediate notifications regarding system performance. This enables quick decision-making and troubleshooting, improving overall efficiency. In case of alarms or issues like a temperature sensor failure or an actuator malfunction, supervisors can receive instant intimations through their user devices and take appropriate actions such as scheduling maintenance or reconfiguring the system remotely, all of which contribute to the optimal performance and energy savings of the HVAC system.

Cleaning data: The collected data is cleaned before proceeding with any analysis or modelling, as raw data often contains inconsistencies, missing values, or outliers that can distort the results. The first step in data cleaning is identifying and handling missing data. This might involve imputing missing values based on the average, median, or using more advanced methods like interpolation, or even discarding rows or columns with too much missing data. Next, data normalization and standardization are important, especially when different field devices might produce data in varying scales or units (e.g., temperature in Celsius vs. Fahrenheit). Removing outliers is another essential part of the cleaning process.

Exploratory Data Analysis (EDA): Once the data is cleaned, EDA can be performed to better understand the underlying patterns and relationships within the HVAC system's performance. EDA typically involves visualizing the data using tools like histograms, scatter plots, and time-series graphs to identify trends, correlations, and seasonality in variables like temperature, humidity, or energy consumption. It also helps to uncover patterns that can guide further analysis, like detecting recurring faults or inefficiencies. In HVAC systems, this might involve understanding the normal operating conditions of different zones or identifying unusual fluctuations in parameters that could suggest a need for maintenance. Statistical methods such as correlation analysis or hypothesis testing may also be used to validate these observations.

Validating HVAC faults: Clustering, a type of unsupervised machine learning, plays an important role in validating HVAC faults. By grouping similar data points based on their features, clustering algorithms such as K-means, DBSCAN, or hierarchical clustering can identify patterns of abnormal behaviour in the system that might otherwise go unnoticed. For example, if certain HVAC units are consistently consuming more energy or operating outside their typical temperature range, clustering can group these incidents together, helping pinpoint faulty equipment or areas in need of attention. The clustering model will group instances of similar behaviour, and anomalies within these groups can be flagged as potential faults.

Train a model: A model building begins with data pre-processing, where data is cleaned, transformed, and prepared for analysis. Next, appropriate algorithms such as regression models, decision trees, or clustering techniques are selected based on the type of analysis (e.g., fault detection, energy consumption prediction). The chosen model is then trained using historical data to learn patterns and relationships.

Evaluate a model: After training, model evaluation is performed using metrics like accuracy, precision, recall, or root mean squared error (RMSE) depending on the problem type. This evaluation ensures the model's performance is robust and generalizes well to unseen data. Cross-validation or splitting the data into training and test sets helps mitigate overfitting and ensures reliable results.

Build a model: Model building and maintenance are crucial for long-term performance. As new data is collected from the HVAC system, the model needs periodic retraining to adapt to changes in system behaviour or environmental conditions. This might involve recalibrating the model or even retraining it from scratch if there are significant shifts in data trends. Regular monitoring of the model's performance, as well as the ongoing analysis of real-world outcomes, ensures that the model remains effective in detecting faults, optimizing energy consumption, or providing accurate forecasts. Continuous evaluation and maintenance ensure the model provides value over time and can adjust to evolving system dynamics.

Deploy a model: Once the HVAC fault detection model has been trained and evaluated, the next step is deployment. During deployment, the model is integrated into the Building Management System (BMS), allowing it to process real-time data from the HVAC system. The deployment involves setting up a seamless flow of data from the field devices (sensors, controllers, etc.) into the model, ensuring that it continuously monitors the system's performance. In this phase, the model is typically deployed on a server or cloud platform where it can scale and process large volumes of data efficiently. The system should also have the capability to update or retrain the model periodically as new data comes in, ensuring the model adapts to any changes in system behaviour. This step ensures that the model is actively working to detect faults and optimize the system.

Fault detection: As the model processes data from the HVAC system, it continuously checks for any anomalies, inefficiencies, or deviations from normal operating conditions. When a fault is detected, such as a malfunctioning sensor, abnormal temperature readings, or excessive energy consumption, the model compares the situation against known patterns of faults it has learned during training. If the model identifies an issue, it triggers an alert, classifying the nature of the fault, its severity, and which part of the HVAC system is impacted. For instance, if a certain zone's temperature is consistently deviating from set points, the model might flag this as a cooling unit issue. This detection process can run in real-time or be scheduled to evaluate data periodically.

Intimation of Fault with Remedies: Once the fault is detected, the next step is communicating the issue to the relevant stakeholders for timely action. The BMS 306 receives the notification along with detailed information about the fault, such as its location, possible causes, and recommended remedies. This might include actions like recalibrating a sensor, cleaning filters, or scheduling a repair for malfunctioning equipment. In addition to the BMS 306, supervisors or maintenance staff receive immediate intimation of the fault on their user devices 308 (smartphones, tablets, or PCs). This intimation includes a real-time alert with the fault details and suggested corrective actions, ensuring that they can take quick, informed decisions. The user device 308 may also offer an interface for remotely adjusting settings or scheduling maintenance tasks. This process helps minimize system downtime, ensure quick resolution of issues, and maintain optimal operation of the HVAC system, all while providing a seamless feedback loop between the model, BMS, and the users.

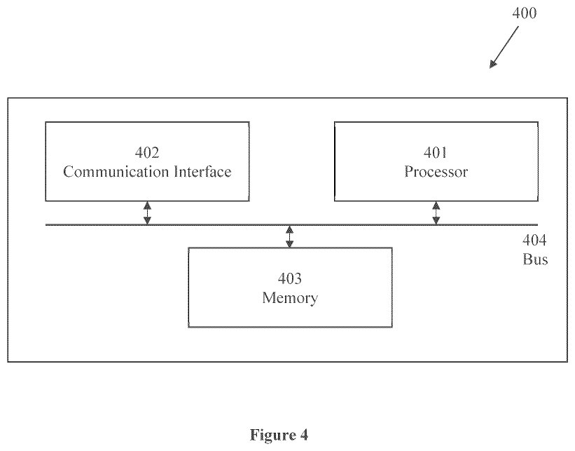

FIG. 4 illustrates a schematic diagram of an apparatus 400 for optimizing a HVAC system according to an embodiment of the disclosure. The optimizing apparatus 400 includes a processor 401, a communication interface 402, and a memory 403. The processor 401, the communication interface 402, and the memory 403 may be connected to each other via a bus 404. The bus 404 may be a peripheral component interconnect (peripheral component interconnect, PCI) bus, an extended industry standard architecture (extended industry standard architecture, EISA) bus, or the like. The bus 404 may be classified into an address bus, a data bus, a control bus, and the like. For ease of representation, the bus is represented by using only one line in FIG. 4, but it does not indicate that there is only one bus or one type of bus. The processor 401 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 403 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may conduct a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined, or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or another programmable data processing apparatus, a function/operation specified in the flowchart and/or the block diagram is implemented. The program code may be completely executed on a computer, partially executed on a computer, independently performed as a software package, partially executed on a computer, and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

We claim:

1. A method for optimizing a HVAC system, comprising the steps of:
receiving, from a remote building management (RBM) platform, a plurality of multivariate data of the HVAC system;
segmenting the plurality of multivariate data into one or more clusters by at least one clustering technique, wherein each cluster in the one or more clusters represents at least one operational pattern of the HVAC system;
analyzing the plurality of multivariate data contained in the one or more clusters to identify patterns to suggest inefficiencies in the at least one operational pattern of the HVAC system or identify deviations in the at least one operational pattern indicating faults within the HVAC system;
automatically recommending one or more remedies for the suggested inefficiencies or the identified deviations in the at least one operational pattern to optimize the HVAC system using a plurality of predefined criteria; and
training a model to automatically detect inefficiencies or deviations in the at least one operational pattern in the HVAC system.

2. The method as claimed in claim 1, wherein the at least one operational pattern is selected from a group of time-based patterns, zone-based patterns, temperature patterns, humidity patterns, airflow patterns, or a combination of the above.

3. The method as claimed in claim 1, wherein each cluster in the one or more clusters represents at least one energy consumption pattern of the HVAC system, the at least one energy consumption pattern is related to the at least one operational pattern of the HVAC system.

4. The method as claimed in claim 1, wherein the step of analyzing includes correlating the at least one operational pattern to the corresponding at least one energy consumption pattern to suggest inefficiencies or identify deviations in the at least one operational pattern of the HVAC system.

5. The method as claimed in claim 1, wherein the step of training includes:
incorporating constant feedback to the model via the step of analyzing and recommending; and
incorporating feedback from maintenance interventions and past energy performance data of the HVAC system.

6. The method as claimed in claim 5, wherein training the model includes providing feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

7. The method as claimed in claim 1, further comprising alerting a user about the identified inefficiencies or the predicted potential inefficiencies in the at least one operational pattern of the HVAC system.

8. The method as claimed in claim 7, wherein the step of alerting comprises:
triggering a SMS alert to the user on a user device about the identified inefficiencies or the predicted potential inefficiencies in the at least one operational pattern of the HVAC system along with the one or more remedies.

9. The method as claimed in claim 1, further comprising implementing, based on a user's response, at least one or more remedies on the HVAC system.

10. The method as claimed in claim 1, wherein the suggested inefficiencies or identified deviations indicates an undue high-temperature zone, an undue low-temperature zone, an undue high airflow zone, an undue low airflow zone, an undue high-humidity zone, an undue low-humidity zone, or a combination of the above.

11. The method as claimed in claim 1, wherein the at least one clustering technique is selected from a group of k-means clustering, hierarchical clustering, and Gaussian Mixture Models (GMM).

12. The method as claimed in claim 1, further comprising cleaning the plurality of multivariate data before segmenting the plurality of multivariate data and performing a data analysis on the cleaned multivariate data.

13. A system for optimizing a HVAC system, comprising:
a data receiving module configured to receive a plurality of multivariate data of the HVAC system from a remote building management (RBM) platform;
a data segmenting module configured to segment the plurality of multivariate data into one or more clusters by at least one clustering technique, wherein each cluster in the one or more clusters represents at least one operational pattern of the HVAC system;
a data analyzing module configured to analyze the plurality of multivariate data contained in the one or more clusters to identify patterns to suggest inefficiencies in the at least one operational pattern of the HVAC system or identify deviations in the at least one operational pattern indicating faults within the HVAC system;
a recommendation module configured to automatically recommend one or more remedies for the suggested inefficiencies or the identified deviations in the at least one operational pattern to optimize the HVAC system using a plurality of predefined criteria; and
a training module configured to train a model to automatically detect inefficiencies or deviations in the at least one operational pattern in the HVAC system.

14. The system as claimed in claim 13, wherein the at least one operational pattern is selected from a group of time-based patterns, zone-based patterns, temperature patterns, humidity patterns, airflow patterns, or a combination of the above.

15. The system as claimed in claim 13, wherein each cluster in the one or more clusters represents at least one energy consumption pattern of the HVAC system, the at least one energy consumption pattern is related to the at least one operational pattern of the HVAC system.

16. The system as claimed in claim 13, wherein the data analyzing module further configured to correlate the at least one operational pattern to the corresponding at least one energy consumption pattern to suggest inefficiencies or identify deviations in the at least one operational pattern of the HVAC system.

17. The system as claimed in claim 13, wherein the training module further comprising:
a feedback module configured to provide constant feedback to the model via the data analyzing module and the recommendation module, and further configured to incorporate feedback from maintenance interventions and past energy performance data of the HVAC system.

18. The system as claimed in claim 17, wherein the training module configured to provide feedback over a period of time to help the model to automatically predict potential inefficiencies or deviations in the at least one operational pattern in the HVAC system and automatically recommend one or more remedies for the potential inefficiencies or deviations in the at least one operational pattern of the HVAC system.

19. The system as claimed in claim 13, further comprising an alert module configured to alert a user of the identified inefficiencies or the predicted potential inefficiencies in the at least one operational pattern of the HVAC system by triggering a SMS alert to the user on a user device about the identified inefficiencies or the predicted potential inefficiencies in the at least one operational pattern of the HVAC system along with the one or more remedies.

20. A non-transitory computer-readable medium having stored thereon computer-readable instructions that, when executed by a processor, cause the processor to execute a method for optimizing a HVAC system, comprising the steps of:
receiving, from a remote building management (RBM) platform, a plurality of multivariate data of the HVAC system;
receiving, from a remote building management (RBM) platform, a plurality of multivariate data of the HVAC system;
analyzing the plurality of multivariate data contained in the one or more clusters to identify patterns to suggest inefficiencies in the at least one operational pattern of the HVAC system or identify deviations in the at least one operational pattern indicating faults within the HVAC system;
automatically recommending one or more remedies for the suggested inefficiencies or the identified deviations in the at least one operational pattern to optimize the HVAC system using a plurality of predefined criteria; and
training a model to automatically detect inefficiencies or deviations in the at least one operational pattern in the HVAC system.
